(19) United States
(12) Patent Application Publication
(10) Pub. No.: US 2020/0008197 A1
(43) Pub. Date: Jan. 2, 2020

(54) COMMUNICATION APPARATUS, COMMUNICATION METHOD, WIRELESS COMMUNICATION SYSTEM AND PROGRAM

(71) Applicant: NEC CORPORATION, Tokyo (JP)

(72) Inventors: Tansheng LI, Tokyo (JP); Yohei HASEGAWA, Tokyo (JP); Takeo ONISHI, Tokyo (JP); Takahiro NOBUKIYO, Tokyo (JP)

(73) Assignee: NEC CORPORATION, Tokyo (JP)

(21) Appl. No.: 16/337,770

(22) PCT Filed: Sep. 26, 2017
(86) PCT No.: PCT/JP2017/034707

§ 371 Date: Mar. 28, 2019

(30) Foreign Application Priority Data
Sep. 28, 2016 (JP) 2016-189911

(51) Int. Cl. H04W 72/04; H04L 25/02; H04L 5/00; H04L 27/26; H04W 80/06

(52) U.S. Cl. CPC H04W 72/0453; H04L 25/022; H04W 80/06; H04L 27/2666; H04L 5/0098

(57) ABSTRACT

A communication apparatus is provided with a communication part, a response index calculation part, and a determination part. The communication part is configured to be capable of transmitting a packet to the terminal, via frequency carrier(s) of a base station to which the terminal is connected. The response index calculation part calculates a response index of the packet. The determination part determines the number of frequency carrier(s) used by the terminal in accordance with the result of the response index calculation by the response index calculation part. Determining a number of frequency carriers being used includes determining the number of LTE carrier waves being used by the terminal.

### CROSS-REFERENCE TO RELATED APPLICATIONS

The present application claims priority from Japanese Patent Application No. 2016-189911 (filed on Sep. 28, 2016) the content of which is hereby incorporated in its entirety by reference into this specification.

### TECHNICAL FIELD

The present invention relates to a communication apparatus, a communication method, a wireless communication system and a program. In particular, the invention relates to a communication apparatus, a communication method, a wireless communication system and a program, which execute a method of identifying a wireless environment where execution is performed by a apparatus in a network on an Internet side by a base station.

### BACKGROUND

In recent years, traffic in mobile networks is increasing with the popularization of smartphones. As one technology responding to the traffic increase, Carrier Aggregation (CA) introduced from LTE (Long Term Evolution) Advanced is cited. With CA, by using a plurality of Component Carriers (CC) at the same time, it is possible to attain wireless throughput theoretically several times larger in comparison with conventional LTE that uses a single CC for a communication band between base station and user terminal.

However with regard to the CA technology, communication performance thereof may not be extracted to the maximum. This occurs due to a mismatch of communication control of a wireless layer where the CA technology is applied and a transport layer where communication control is performed independently. With regard to communication protocol of a transport layer used as a standard in the Internet, TCP (Transmission Control Protocol), for example, is known. A general transport layer protocol as represented by TCP, performing control without regard to lower layer (for example, control without regard to communication speed in lower layer), may not match communication volume in the lower layer. As a result, since the greater part of mobile traffic is Internet traffic, there is a possibility of deterioration in communication performance occurring due to a malfunction in a wireless layer and an upper layer of the Internet. For example, if there is a delay increase or packet loss due to deterioration in general wireless signal quality, TCP congestion is judged to have occurred, congestion control is performed, and as a result there is a possibility of a considerable decline in throughput. Thereafter, even if wireless quality recovers, since throughput recovery by a TCP control method is slow, the usage rate of wireless resources declines, and the expected performance of CA cannot be realized.

In a case where a configured range of parameters in a transport layer does not match communication characteristics in the lower layer, there is a large effect on communication performance. For example, if the transport layer performs control using a parameter (for example, transmission rate) for Non-CA, in a terminal where CA execution is being performed, since communication speed is lower than the terminal communication volume, the usage rate of the wireless resources deteriorates, and expected performance of CA cannot be exhibited. If the transport layer adds a parameter (for example, transmission rate) applicable to CA, to a terminal where CA execution is not being performed, with processing performance of a mobile network being insufficient, processing time increases and delay increases.

Therefore, in order to achieve an improvement in performance in wireless communication, recognition of the wireless environment of an end terminal is important. If the wireless environment of a terminal can be recognized, it is possible to limit the control range of a parameter used by the upper layer, and by rapidly adjusting to an optimal setting, it is possible to improve communication performance.

For example, Patent Literature 1 discloses technology by which, in a cognitive base station apparatus having a switch part provided with a wireless module, a MAC processing part, and a TCP control part, the wireless module uses a wireless environment recognition part (for example, a sensor antenna), the wireless environment recognition part obtains wireless information from the wireless module, and using this information the TCP control part adjusts a TCP parameter, and mis-triggering of congestion control is reduced. In this case, in Patent Literature 1, the wireless information, for example, may be RSSI (Received Signal Strength Indication), background noise level, modulation method, communication-waiting data volume stored in a transmission buffer, the number of times a NACK (Negative ACKnowledgement) signal indicating transmission failure is received from a partner station, or defect rate of wireless frames received from a partner station.

Patent Literature 2 discloses that the numerical value of radio field intensity or wireless link state (whether a link is in a connected state or a disconnected state) is detected, and network delivery is controlled based on the detection result. Patent Literature 2 discloses that identified network environment information is stored in a management database. The management database is for controlling application layers or the like.

Patent Literatures 3 and 4 disclose technology in which an apparatus having a wireless function directly measures a wireless environment. That is, the Patent Literature discloses a function (wireless information acquisition function) to obtain information from a wireless layer in order to measure the wireless environment. In the technology of Patent Literature 3 and 4, transmission (notification to another apparatus) of a result of measuring the wireless environment is necessary, and Patent Literature 3 and 4 disclose a function to notify the measurement result to other apparatuses (wireless environment notification function), and a function whereby other apparatuses receive the notification (wireless environment receiving function).

Patent Literature 5 discloses technology to detect change in permitted bandwidth by using transmission speed and reception interval of ACK signals.

[Patent Literature 1]

Japanese Patent Kokai Publication No. JP2010-213013A

[Patent Literature 2]

Japanese Patent Kokai Publication No. JP2004-266330A

[Patent Literature 3]

Japanese Patent Kokai Publication No. JP2016-076887A

[Patent Literature 4]

International Publication No. WO2010/032675

[Patent Literature 5]

Japanese Patent Kokai Publication No. JP2008-113226A

### SUMMARY

It is to be noted that the respective disclosures of the abovementioned cited technical literature are incorporated herein by reference thereto. The following analysis is given according to the present inventors.

In Patent Literatures 1 and 2, a wireless environment identification part is present inside an apparatus having a wireless function. Identification of the wireless environment is performed by a physical layer or a MAC (Media Access Control) layer. In this case, communication between different layers of an OSI (Open Systems Interconnection) reference model is necessary, and in addition, in a case of being applied, this is limited to a apparatus in which there is a wireless function. Therefore, the wireless environment identification part cannot give notification of obtained wireless information to a communication apparatus on an Internet side by a base station. That is, the technology disclosed in Patent Literatures 1 and 2 cannot be applied to a communication apparatus on the Internet side by a base station.

In the technology of Patent Literatures 1 and 2, in a wireless environment for identification, since it is not possible to obtain information as to whether or not use is being made of carrier aggregation technology using a plurality of carrier waves, as a result it is difficult to prevent deterioration in communication performance in an LTE network.

Patent Literatures 3 and 4 stay with disclosing the abovementioned 3 functions, and with the abovementioned 3 functions it is not possible to determine the usage state of the plurality of carrier waves (usage state of carrier aggregation) at a terminal. For example, referring to paragraph 0053 of Patent Literature 4, there is a disclosure that mobile station apparatus information and measurement information are inputted in order to determine the state of Aggregation. Or, in paragraph 0067 of the same Patent Literature, there is a disclosure that a determination is comprehensively made from obtained information as to whether or not the mobile station apparatus requires Carrier Aggregation, and there is no specific disclosure related to determination of usage state of carrier aggregation. In this way, with the 3 functions disclosed in Patent Literatures 3 and 4, it is not possible to determine the usage state of carrier aggregation.

In this point, technology of Patent Literature 5 is similar, and with the technology disclosed in Patent Literature 5, it is not possible to distinguish a single wave in a quiet environment and carrier aggregation.

It is a goal of the present invention to provide a communication apparatus, a communication method, a wireless communication system and a program, which enable identification of a wireless environment of an end terminal.

According to a first aspect of the present invention and disclosure, a communication apparatus is provided that includes: a communication part for enabling transmission of a packet to a terminal via frequency carrier(s) of a base station to which the terminal is connected; a response index calculation part for calculating a response index for the packet; and a determination part for determining a number of the frequency carrier(s) of the terminal being used, in accordance with a response index calculation result of the response index calculation part.

According to a second aspect of the present invention and disclosure, a communication method is provided for a communication means for enabling transmission of a packet to a terminal via frequency carrier(s) of a base station to which the terminal is connected, the method comprising: calculating a response index of the packet; and determining a number of the frequency carriers of the terminal being used, in accordance with a response index calculation result.

According to a third aspect of the present invention and disclosure, a wireless communication system is provided that includes: a terminal; a base station to which the terminal is connected; and a communication apparatus that enables transmission of a packet to the terminal via frequency carrier(s) of the base station; wherein the communication apparatus includes: a response index calculation means for calculating a response index of the packet; and a determination means for determining a number of the frequency carrier(s) of the terminal being used, in accordance with a response index calculation result of the response index calculation means.

According to a fourth aspect of the present invention and disclosure, a program is provided to make a computer execute control of a communication apparatus that enables transmission of a packet to a terminal via frequency carrier(s) of a base station to which the terminal is connected, the program including: a response index calculation process of calculating a response index of the packet; and a determination process of determining a number of the frequency carrier(s) of the terminal being used, in accordance with a response index calculation result of the response index calculation process. It is to be noted that this program may be recorded on a computer-readable storage medium. The storage medium may be non-transient such as semiconductor memory, a hard disk, a magnetic recording medium, an optical recording medium or the like. The present invention may be embodied as a computer program product.

According to the various viewpoints of the present invention and disclosures, there are provided: a communication apparatus, a communication method, a wireless communication system and a program, which enable identification of the number of carriers being used by a terminal, and which contribute to preventing deterioration in communication performance.

### BRIEF DESCRIPTION OF THE DRAWINGS

FIG. 1 is a diagram for describing an outline of an exemplary embodiment.

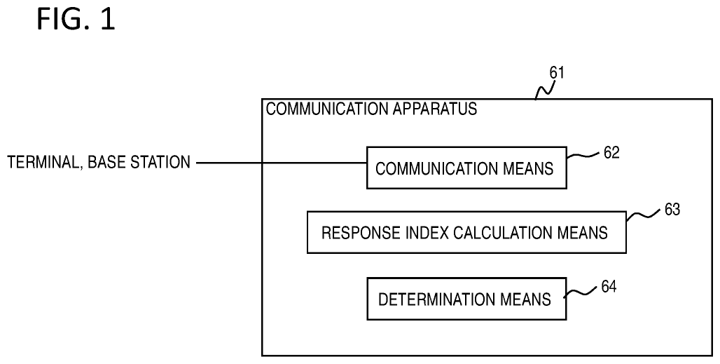

FIG. 2 is a diagram showing an example of a configuration of a communication network to which is applied a communication apparatus according to a first exemplary embodiment.

FIG. 3 is a block diagram showing an example of a hardware configuration of the communication apparatus according to the first exemplary embodiment.

FIG. 4 is a block diagram showing an example of a hardware configuration of a terminal apparatus according to the first exemplary embodiment.

FIG. 5 is a block diagram showing an example of a processing configuration of a communication apparatus and a terminal apparatus disclosed in FIG. 2.

FIG. 6 is a block diagram showing an example of a protocol configuration of a U-Plane of a terminal communication part of the terminal apparatus disclosed in FIG. 5.

FIG. 7 is a block diagram showing an example of a configuration of the communication part shown in FIG. 5.

FIG. 8 is a flowchart showing an example of operations of the communication apparatus of the first exemplary embodiment.

FIG. 9 is a block diagram showing an example of a configuration of the communication apparatus according to a second exemplary embodiment.

FIG. 10 is a flowchart showing an example of operations of the communication apparatus of the second exemplary embodiment.

FIG. 11 is a block diagram showing an example of a configuration of the communication apparatus according to a third exemplary embodiment.

FIG. 12 is a flowchart showing an example of operations of the communication apparatus of the third exemplary embodiment.

FIG. 13 is a block diagram showing an example of a configuration of the communication apparatus according to a fourth exemplary embodiment.

FIG. 14 is a flowchart showing an example of operations of the communication apparatus of the fourth exemplary embodiment.

FIG. 15 is a block diagram showing an example of a configuration of the communication apparatus according to a fifth exemplary embodiment.

FIG. 16 is a flowchart showing an example of operations of the communication apparatus of the fifth exemplary embodiment.

### PREFERRED MODES

First, a description is given concerning an outline of an exemplary embodiment. It is to be noted that reference symbols in the drawings attached to this outline are added to respective elements for convenience, as examples in order to aid understanding, and in the description of the outline there is no intention to limit the invention in any way.

A communication apparatus 61 according to an exemplary embodiment is provided with a communication part 62, a response index calculation part 63, and a determination part 64. The communication part 62 is configured to be capable of transmitting a packet to a terminal, via frequency carrier(s) of a base station to which the terminal is connected. The response index calculation part 63 calculates a response index for the packet. The determination part 64 determines a number of frequency carriers used by the terminal in accordance with a result of the response index calculation by the response index calculation part 63.

A detailed description will be given later, but in a case where for 1 terminal a plurality of MAC layers and 1 RLC layer are connected, the behavior of the RLC layer is reflected in the behavior of the transport layer. In other words, it is possible to infer the present state of the RLC layer from the behavior of the transport layer of the communication apparatus 61 connected to the terminal. Therefore, the communication apparatus 61 quantifies how a response packet responding to a packet transmitted toward the terminal behaves (how the response packet is processed at a terminal) as a response index, and determines the number of frequency carriers used at the terminal based on the response index in question. That is, the communication apparatus 61 estimates a radio wave used by the terminal from a characteristic of communication of a layer different from a wireless layer. As a result, it is possible to identify the number of carriers used by a terminal, and it is possible to prevent deterioration of communication performance.

A more detailed description is given concerning specific exemplary embodiments below, making reference to the drawings. It is to be noted that in each of the exemplary embodiments, the same symbols are attached to the same configuration elements and descriptions thereof are omitted.

### First Exemplary Embodiment

A more detailed description is given concerning a first exemplary embodiment, using the drawings.

### Description of Configuration

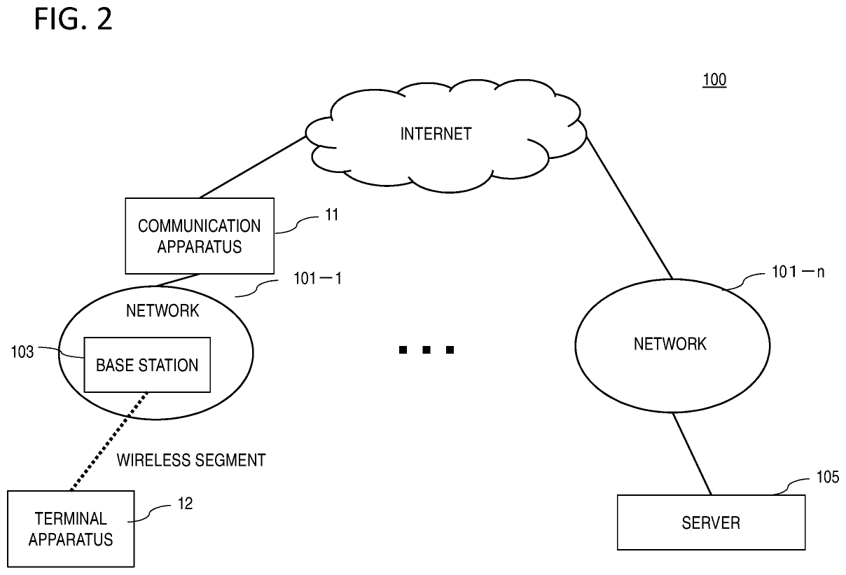

FIG. 2 is a diagram showing an example of a configuration of a communication network (wireless communication system) to which a communication apparatus 11 according to a first exemplary embodiment of the present invention is applied.

The abovementioned communication network 100 is provided with networks 101-1 to 101-n (n is a natural number; the same applies below). The networks 101-1 to 101-n include different communication types (wired and wireless) for end terminals. The networks 101-1 to 101-n include, for example, a LTE public mobile network, a home Wi-Fi (registered trademark; the same applies below), an in-house LAN, and the like.

It is to be noted that in the above, 3G is an abbreviation for 3rd Generation, Wi-Fi is an abbreviation for Wireless Fidelity, and LAN is an abbreviation for Local Area Network.

The terminal apparatus 12 accesses a server on the Internet, via a corresponding network 101, and performs data communication. The terminal apparatus 12 can use carrier aggregation which is LTE Advanced technology.

In the present exemplary embodiment, an example is cited in which the communication apparatus 11 is installed on a communication path, in a connection part of the mobile network and the Internet. Clearly, the installation location of the communication apparatus 11 is not limited to a connection part of the mobile network and the Internet, and may be at an apparatus on another communication path outside of the connection part. For example, the communication apparatus 11 may be installed in a server 105 on the communication path.

### Hardware Configuration

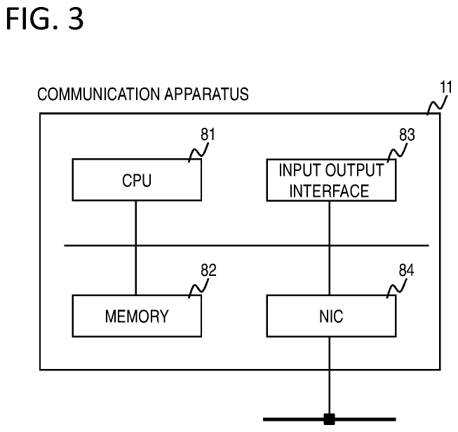

Next a description is given of a hardware configuration of various types of apparatus configuring the communication network 100 according to the first exemplary embodiment. FIG. 3 is a block diagram showing an example of a hardware configuration of the communication apparatus 11 according to the first exemplary embodiment.

### Communication Apparatus

The communication apparatus 11, for example, is provided with a configuration exemplified in FIG. 3. For example, the communication apparatus 11 is provided with a CPU (Central Processing Unit) 81, a memory 82, an input output interface 83, and an NIC (Network Interface Card) 84 which is a communication means, connected to each other by an internal bus.

However, the configuration shown in FIG. 3 is not intended to limit the hardware configuration of the communication apparatus 11. The communication apparatus 11 may include hardware not shown in the drawings, and need not be provided with the input output interface 83, in accordance with requirements. The number of CPUs included in the communication apparatus 11 is not intended to be limited to the example shown in FIG. 3, and for example, a plurality of CPUs may be included in the communication apparatus 11.

The memory 82 may be RAM (Random Access Memory), ROM (Read Only Memory), or an auxiliary storage apparatus (hard disk etc.).

The input output interface 83 is a means that forms an interface of a display apparatus or input apparatus not shown in the drawings. The display apparatus is, for example, a liquid crystal display or the like. The input apparatus is, for example, an apparatus that receives a user operation such as that of a keyboard, a mouse, or the like.

Functionality of the communication apparatus 11 is realized by various types of processing module described later. The processing modules in question, for example, are realized by the CPU 81 executing programs stored in the memory 82. The programs may be downloaded via a network, or may be updated using a storage medium that stores the programs. Furthermore, the abovementioned processing modules may be realized by a semiconductor chip. That is, it is sufficient to have a means that executes functions performed by the abovementioned processing modules, by some type of hardware and/or software.

### Terminal Apparatus

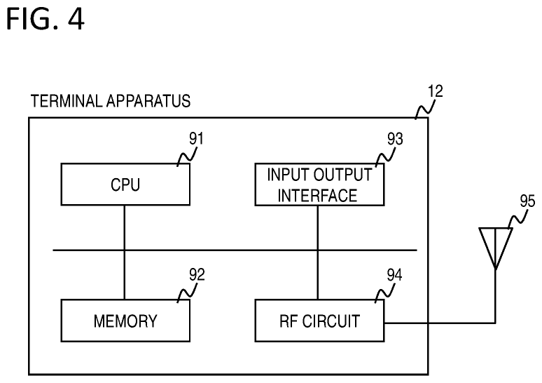

The terminal apparatus 12, for example, is provided with a configuration exemplified in FIG. 4. The terminal apparatus 12 is configured by including a RF (Radio Frequency) circuit 94 provided with an antenna 95. The RF circuit 94 is a circuit for realizing wireless communication, and performs transfers of wireless signals with a base station 103 via the antenna 95. It is to be noted that among the hardware provided by the terminal apparatus 12 a description of hardware that is in common with the communication apparatus 11 is omitted.

Since the hardware configuration of the base station 103 is evident to those skilled in the art, a description is omitted.

Continuing, a description is given concerning a processing configuration (processing module) of the communication apparatus 11 and the terminal apparatus 12.

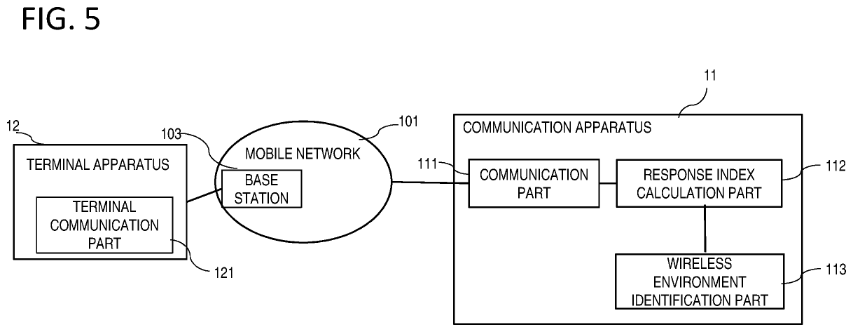

FIG. 5 is a block diagram showing an example of a processing configuration of the communication apparatus 11, the terminal apparatus 12 and the mobile network 101, shown in FIG. 2. The terminal apparatus 12 is provided with a terminal communication part 121. The mobile network 101 is provided with a base station 103. The communication apparatus 11 is provided with a communication part 111, a response index calculation part 112 and a wireless environment identification part 113. The terminal communication part 121 of the terminal apparatus 12 is connected to enable communication with the base station 103 of the mobile network 101. The mobile network 101 is connected to enable communication with the communication part 111 of the communication apparatus 11. The response index calculation part 112 is connected to enable communication with the communication part 111 and the wireless environment identification part 113.

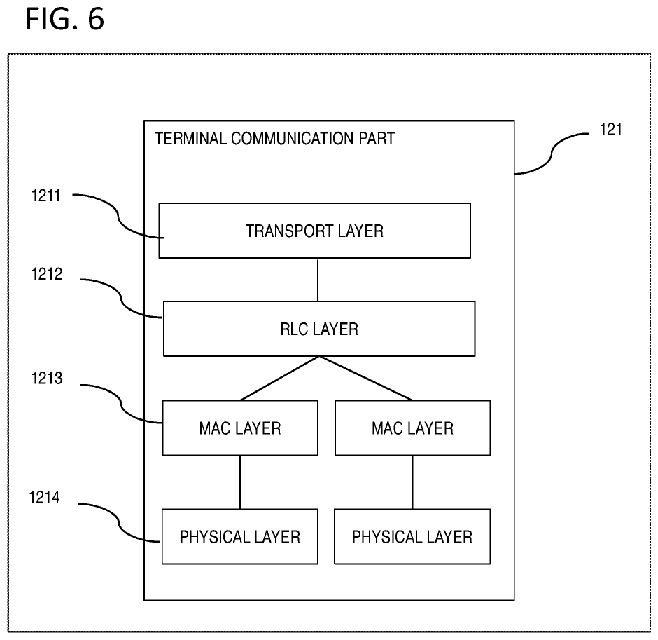

FIG. 6 is a block diagram showing an example of a protocol configuration of a U-Plane (User Plane) for a terminal communication part 121 of the terminal apparatus 12 disclosed in FIG. 5. The terminal communication part 121 is provided with a general configuration of 3GPP (Third Generation Partnership Project) Rel. 10 or later. Specifically, the terminal communication part 121 is provided with a transport layer 1211, an RLC (Radio Link Control) layer 1212, a MAC layer 1213, and a physical layer 1214. It is to be noted that since the relationship with the communication apparatus 11 is evident in FIG. 6, descriptions related to the configuration outside of the terminal communication part 121 are omitted.

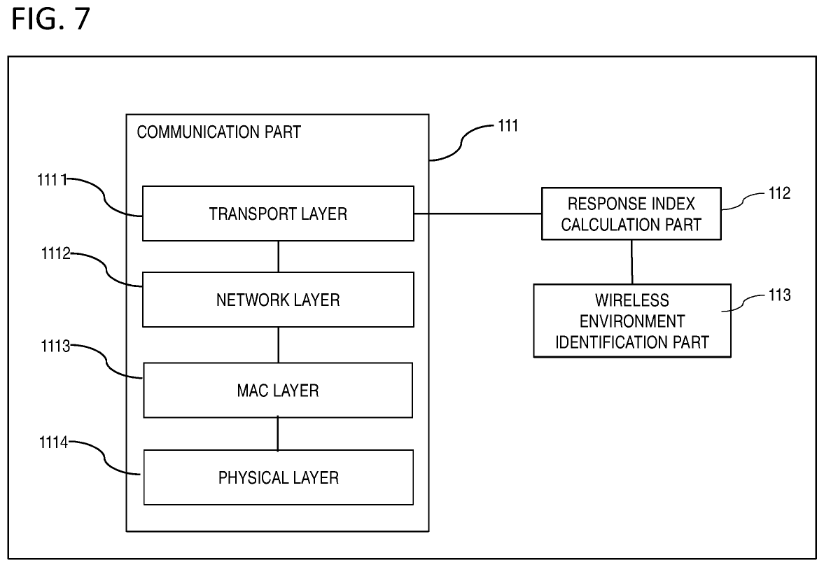

FIG. 7 is a block diagram showing an example of a configuration of the communication part 111 shown in FIG. 5. The communication part 111 is provided with a general configuration of an OSI (Open Systems Interconnection) reference model. Specifically, the communication part 111 is provided with a transport layer 1111, a network layer 1112, a MAC layer 1113, and a physical layer 1114. It is to be noted that since the connection relationship with the response index calculation part 112 is clear in FIG. 7, descriptions related to the configuration outside of the configuration concerned with the communication part 111 (response index calculation part 112, wireless environment identification part 113) are omitted.

The response index calculation part 112 calculates at least one “response index” based on information (for example, received packet) obtained from the transport layer 1111 of the communication part 111. Here, the response index is one or a plurality of physical quantities indicating the behavior of a packet transmitted from the transport layer 1111 in communication with the terminal apparatus 12, and/or a corresponding response packet. Or, the response index can be taken as a physical quantity indicating communication state with regard to the transport layer (a layer different from the wireless layer) of the terminal apparatus 12 and the communication apparatus 11. For example, Round-Trip Time (RTT) is shown as an example of response index. In addition, while not illustrated in FIG. 7, the response index may be calculated with an application layer as the layer different from the wireless layer. For example, the time from a HTTP request command transmission to the time of receiving a response command in response to the request command may be considered as a response index. In addition, while not illustrated in FIG. 7, the response index may be calculated with an IP layer as the layer different from the wireless layer. It is to be noted that the present exemplary embodiment is described mainly using RTT as follows, but the response index is not limited to RTT, and one way delay, throughput, timestamp calculated from communication protocol header, or the like, may be used. The response index calculation part 112 may calculate a physical quantity calculation result. For the physical quantity calculation result, in addition to mean value, median or statistical quantity of each physical quantity, it is possible to use time series data.

The response index calculation part 112 forwards a response index calculated according to information obtained from the transport layer 1111, to the wireless environment identification part 113.

The wireless environment identification part 113 identifies (determines) the usage state of carrier aggregation of the terminal apparatus 12. Specifically, the wireless environment identification part 113 determines the usage state of carrier aggregation based on response index calculated with the current communication.

### Description of Operations

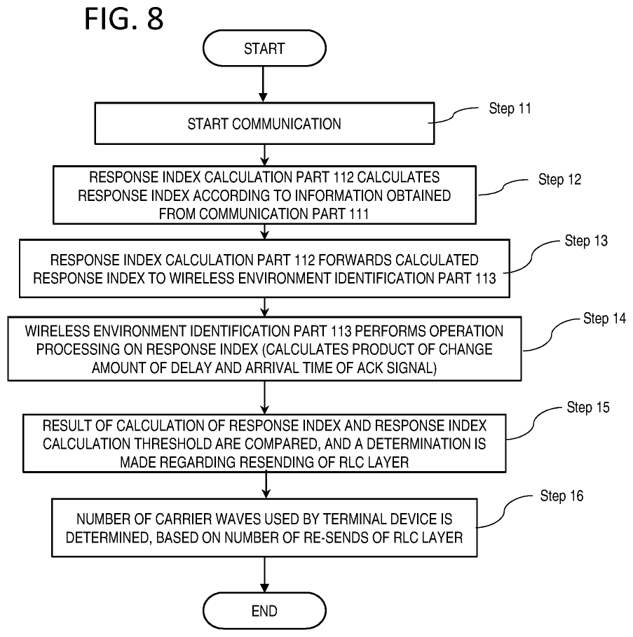

FIG. 8 is a flowchart showing an example of operations of the communication apparatus 11 of the first exemplary embodiment.

When communication is started, the terminal apparatus 12 starts data communication with the communication apparatus 11 (step 11).

The response index calculation part 112 of the communication apparatus 11 is connected to the transport layer 1111 of the communication part 111, and obtains information from the transport layer 1111. For example, the response index calculation part 112 records transmission time of packets (data) transmitted from the transport layer 1111, calculates the time difference until receipt of a corresponding response signal (for example, ACK signal, NACK signal), and calculates this time as the response index (RTT). The response index calculation part 112, for example, may extract a time stamp from a TCP transmission-reception header, and calculate delay by the time stamp. Or the response index calculation part 112 may calculate reception interval for response signals (for example, ACK signal, NACK signal) from the terminal apparatus 12, as a response index. Or the response index calculation part 112 may use the quantity of data transmitted by the communication part 111 and the abovementioned RTT, to calculate throughput as a response index (step 12).

The response index calculation part 112 forwards the calculated response index to the wireless environment identification part 113 (step 13).

The wireless environment identification part 113 identifies the usage state of CA of the terminal apparatus 12 by the following method.

Since in wireless communication in a real environment, the occurrence of error in the communication process is unavoidable, in general standards (for example, LTE) a method of detecting transmission failure and a method of controlling re-transmission are prescribed. When an error occurs in a lower layer, not being able to end communication in an upper layer is well known among those skilled in the art in communication fields. In a reference model of 3GPP defining CA technology in LTE, as shown in FIG. 6, 1 RLC layer 1212 is connected to at least one MAC layer 1213. When data transmission of the MAC layer 1213 is ended, this is reported to the RLC layer 1212. After transmission of all data by the MAC layer 1213 is ended, the RLC layer 1212 reports the data transmission end to the upper layer (transport layer 1211 or the like). Therefore, if a transmission error occurs in any of the MAC layer 1213, since the RLC layer 1212 cannot end data transmission, it waits for a data transmission end signal from the MAC layer 1213. As a result, delay in the RLC layer 1212 and an upper layer thereof increases.

After a fixed time, if the RLC layer 1212 cannot confirm the end of data transmission of the MAC layer 1213, retransmission is automatically performed. When the RLC layer 1212 performs retransmission, delay is added to this, and the transport layer 1211 of the terminal communication part 121 cannot return an ACK (acknowledgement) expressing the end of reception, to the transport layer 1111 of the communication part 111. As a result, the delay of the transport layer 1111 of the communication part 111 suddenly increases, and a lengthening occurs in ACK reception intervals of the transport layer 1111 of the communication part 111. After successful retransmission, since the terminal communication part 121 processes ACK data built up together inside a buffer, in a short time a plurality of ACK are returned to the transport layer 1111 of the communication part 111 from the transport layer 1211 of the terminal communication part 121, and the delay is reversed (ordinary state is normalized). If it is considered that the error rate (error occurrence rate) of each MAC layer 1213 is constant, it is recognized that the probability of an occurrence of an event in which a delay of the transport layer 1111 of the communication part 111 suddenly increases, and the probability of an occurrence of an event in which at the same time the interval of reception of ACK signal suddenly increases, correlate with the number of MAC layer 1213 performing communication. That is, in a case of using CA, the probabilities of the occurrence of an event in which, in a fixed time, delay observed in the transport layer 1111 of the communication part 111 suddenly increases, and the occurrence of an event in which ACK signal reception interval suddenly increases, correlate with the number of carrier waves used by the terminal apparatus 12 at the same time.

The wireless environment identification part 113 determines the usage state of carrier aggregation as a basis of the abovementioned consideration. For example, the wireless environment identification part 113 stores the RTT calculated by the response index calculation part 112, and calculates the mean value of the RTT from the history or time series of the stored RTT. The wireless environment identification part 113 calculates the difference between the RTT instantaneous value and the mean value, in order to compare the instantaneous value of the RTT obtained from the response index calculation part 112 and the calculated mean value. The wireless environment identification part 113 detects an event in which reception interval of an ACK signal suddenly increases at the same time as an event in which delay due to retransmission in the RLC layer suddenly increases. For example, the wireless environment identification part 113 performs multiplication of change amount of delay and change amount of ACK signal reception interval, in order to detect the abovementioned event. That is, the wireless environment identification part 113 performs computation processing such as arithmetic processing, statistical processing and the like, with respect to the response index obtained from the response index calculation part 112 (step 14).

The wireless environment identification part 113 compares the calculation result with respect to the response index executed in step 14, with “response index computation threshold” set in advance, and makes a determination regarding retransmission for the RLC layer 1212 of the terminal apparatus 12. For example, the wireless environment identification part 113 compares the difference between the RTT instantaneous value and the mean value as the response index calculation result, with the “response index computation threshold” set in advance. As a result of the comparison, if the response index calculation result exceeds the response index calculation threshold, the wireless environment identification part 113 determines that the RLC layer 1212 of the terminal apparatus 12 has performed retransmission. For example, retransmission by the RLC layer 1212 of the terminal communication part 121 is assumed to take T1 seconds. In this case, when retransmission of the RLC layer 1212 occurs, delay increases T1 seconds, and reception interval of ACK signals also increases T1 seconds. Therefore, if the response index calculation result exceeds T1 times T1, the wireless environment identification part 113 judges that re-transmission has been performed in the RLC layer 1212 of the terminal apparatus 12 (step 15).

The wireless environment identification part 113 records the number of events in which the response index calculation result has exceeded the response index calculation threshold and the time of occurrence of the events, recorded in step 15. The wireless environment identification part 113 compares the number of occurrences of the event in a fixed time period and the carrier waves number threshold, and calculates the number of carrier waves being used by the terminal apparatus 12. For example, consider a case where an event for which the difference between the RTT instantaneous value and the mean value exceeds a response index calculation threshold, occurs N times a second, and the carrier waves number threshold (CA determination threshold) is set to M times per second. In this case, for example if N is 3 and M is 2, the wireless environment identification part 113 determines that the terminal apparatus 12 has invoked CA. It is to be noted that the abovementioned N and M clearly may have values other than those of the examples. It is to be noted that a threshold value corresponding to the number of carrier waves is set by a field test executed in advance using a terminal (step 16).

In the present exemplary embodiment, the usage state of carrier aggregation is identified, and the number of carrier waves in use is calculated, but the present invention is not limited thereto. For example, the implementation state of SU-MIMO (Single User-Multi Input Multi Output) may be identified, and the number of multiplex layers with the same carrier waves may be identified. SU-MIMO is technology in which a plurality of antennas and a plurality of wave carriers are used, and speeding up of wireless transmission is realized by executing a plurality of data communications at the same time, with a 1 to 1 relationship between base station and terminal apparatus.

### Description of Effect

As described above, in the communication apparatus 11 of the first exemplary embodiment, the occurrence of a unique point (delay that suddenly increases) with regard to communication in a layer (for example, transport layer) that is different from the wireless layer, is taken as being due to re-transmission of data in the wireless layer (for example, RLC layer). Since a correlation is recognized between the probability that data re-transmission occurs in a wireless layer in wireless communication, and the number of carrier waves used by the terminal apparatus 12, the communication apparatus 11 can estimate the number of times data re-transmission occurs in a wireless layer from the response index of the transport layer. Furthermore, the communication apparatus 11 identifies whether or not the terminal apparatus 12 uses CA, from an estimated number of data re-transmissions, and also, if CA is used, estimates the number of Component Carriers. That is, the response index calculation part 112 calculates response index of the transport layer 1111 during communication with the terminal apparatus 12 from the communication part 111, and forwards this to the wireless environment identification part 113. The wireless environment identification part 113 operates as a determination means for determining the number of the abovementioned frequency carriers used based on the response index calculated by the response index calculation part 112, and identifies the number of carrier waves being used by the terminal apparatus 12. If the quantity of carriers being used by the terminal apparatus 12 can be identified, the communication apparatus 11 can prevent deterioration in communication performance by executing appropriate control in accordance with the number of carriers being used.

### Second Exemplary Embodiment

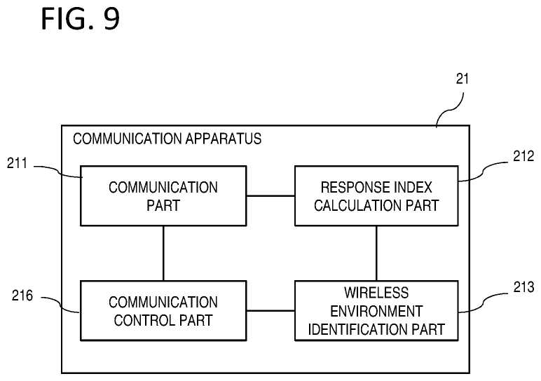

FIG. 9 is a block diagram showing a configuration example of a communication apparatus 21 according to a second exemplary embodiment of the invention.

The communication apparatus 21 is provided with a communication part 211, a response index calculation part 212 and a wireless environment identification part 213. The response index calculation part 212 is connected to enable communication with the communication part 211. The communication control part 216 is connected to enable communication with the communication part 211 and the wireless environment identification part 213.

The response index calculation part 212 calculates at least one response index from a transport layer of the communication part 211, similar to the first exemplary embodiment. Here, as described above, a response index is one or a plurality of physical quantities during communication. The physical quantity is, for example, RTT, one-way delay, transmission throughput, communication speed, timestamp calculated from a header in a communication protocol, or the like. The response index calculation part 212 may calculate the response index from a layer different from the transport layer of the communication part 211. For example, if an application or protocol in an upper layer (for example, application layer) with respect to the transport layer has a function for recording time, the response index may be calculated from this time.

The response index calculation part 212 calculates the response index for the current communication (calculates response index in real time). For example, the response index calculation part 212 records the time of packet transmission, and the time of reception of an ACK signal in response to the transmitted packet, and the result of calculating the difference thereof is the round-trip delay. The response index calculation part 112 may calculate a response index calculation result. For the response index calculation result, for example, in addition to mean value, median, number of occurrences in a fixed time period, or statistical quantity, of respective response indexes, it is possible to use time series data.

The response index calculation part 212 forwards the response index or calculation result calculated by the communication part 211 to the wireless environment identification part 213.

The wireless environment identification part 213 calculates the number of carrier waves being used by a terminal apparatus 12, based on the change amount of response index. In LTE communication, the RLC layer of the terminal apparatus 12 communicates with at least one MAC layer, similar to the first exemplary embodiment. When an error occurs in the MAC layer, as a result of the error escalating to an upper layer, a timeout occurs and the RLC layer performs re-transmission. As a result, the behavior of the transport layer is affected. Specifically, since re-transmission by the RLC layer takes time, delay in the transport layer suddenly increases. Since data transmission of the RLC layer cannot end until re-transmission is ended, the arrival time of the ACK signal becomes lengthy. When the terminal apparatus 12 uses CA, the RLC layer of the terminal apparatus 12 communicates with at least two MAC layers. Therefore, if a transmission error occurs in any of the MAC layer, since the RLC layer performs a timeout or a re-transmission, along with the delay in the transport layer suddenly increasing, a lengthening of reception interval of ACK signals occurs. In a case where the error rate of each MAC layer of the terminal apparatus 12 is constant, the probabilities of the occurrence of an event in which the delay of the transport layer of the communication part 211 suddenly increases, and of an event in which at the same time the reception interval of ACK signals suddenly increases, correlate with the number of MAC layers performing communication. That is, in a case of using CA, the probability of the occurrence of the abovementioned event observed in the transport layer of the communication part 211 in a fixed time period correlates with the number of carrier waves used by the terminal apparatus in the same time.

In order to detect an event in which delay suddenly increases and an event in which ACK signal reception interval suddenly increases at the same time, the wireless environment identification part 213 calculates the amount of change in delay and the amount of change in ACK signal reception interval. For example, the wireless environment identification part 213 multiplies the amount of change in delay and the amount of change in ACK signal reception interval, and records the number of times this result is greater than or equal to a fixed response index calculation threshold (records the number of times the calculation result exceeds a response index threshold). The wireless environment identification part 213 calculates the probability that the abovementioned number of times occurs in terms of time, compares with carrier waves number threshold (CA identification threshold), and determines the number of carrier waves used by the terminal apparatus 12 at the same time.

The wireless environment identification part 213 forwards (notifies) the number of carrier waves being used by the determined terminal, to the communication control part 216.

The communication control part 216 controls the communication part 211, using the number of carrier waves being used by the terminal apparatus 12 that are received. For example, the communication control part 216 calculates communication volume of the terminal apparatus 12, based on the number of carrier waves being used by the terminal apparatus 12. The communication control part 216 controls transmission speed of the communication part 211, in accordance with communication volume of the terminal apparatus 12 that was calculated.

### Description of Operations

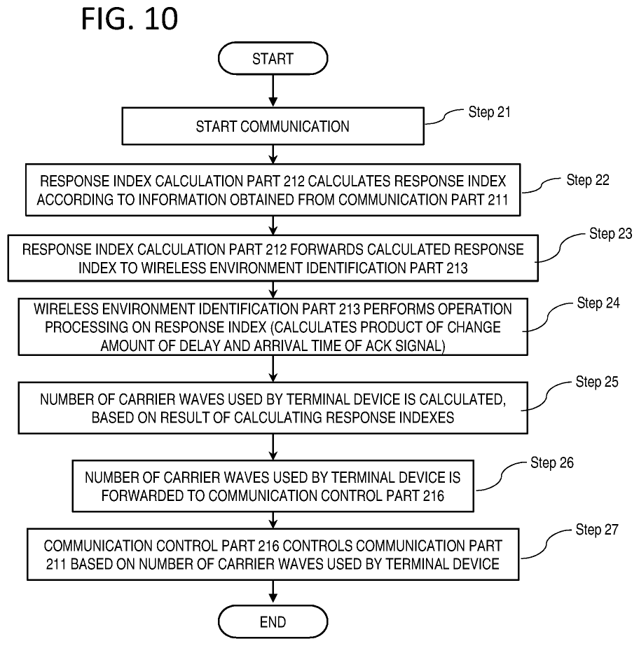

FIG. 10 is a flowchart showing an example of operations of the communication apparatus 21 of the second exemplary embodiment.

When communication starts, the communication part 211 starts communication with the terminal apparatus 12 (step 21).

The response index calculation part 212 of the communication apparatus 21 connects to the communication part 211, and calculates a response index of the communication part 211, for example, RTT. In the RTT calculation, the time of transmitting a packet and the time of receiving an ACK signal corresponding to the transmitted packet are recorded, and the difference between them is calculated as RTT. The response index calculation part 212 calculates reception interval for ACK signals (step 22).

The response index calculation part 212 forwards the calculated response index to the wireless environment identification part 213 (step 23).

The wireless environment identification part 213 performs calculation (operation) with regard to the response index. For example, the wireless environment identification part 213 detects an event in which reception interval for ACK signals suddenly increases at the same time as an event in which delay due to re-transmission in the RLC layer suddenly increases. For example, the wireless environment identification part 213 performs multiplication of change amount of delay and change amount of reception interval of ACK signals, in order to detect the event (step 24).

When the abovementioned calculation result of the response index (multiplication result) exceeds a fixed response index calculation threshold (specifically, a threshold set in advance), the wireless environment identification part 213 determines that re-transmission in the RLC layer of the terminal apparatus 12 has been performed. For example, if re-transmission of the RLC layer of the terminal apparatus 12 takes T1 seconds, when re-transmission in the RLC layer occurs, the delay increases T1 seconds, and the ACK signal reception interval also increases T1 seconds. Therefore, if the calculation result of the response index exceeds T1 times T1, a determination is made that RLC re-transmission of the terminal apparatus 12 has taken place. For example, T1 is assumed to be about 0.1 seconds, but there is no limitation to this numerical value, and clearly other values are possible. The wireless environment identification part 213 compares the number of re-transmissions in the RLC layer in a fixed period of time (for example, 1 second) and the carrier waves number threshold, and calculates the number of carrier waves being used by the terminal apparatus 12 (step 25). For example, as a result of calculating the response index, if there are N occurrences in 1 second of an event exceeding the response index calculation threshold, the wireless environment identification part 213 determines that the number of carrier waves being used by the terminal apparatus 12 is 2. For example, N is 2, but other values are possible.

The wireless environment identification part 213 forwards the number of carrier waves being used by the terminal apparatus 12 that has been calculated, to the communication control part 216 (step 26).

The communication control part 216 controls the communication part 211, based on the number of carrier waves being used by the terminal apparatus 12. For example, the communication control part 216 calculates communication volume of the terminal apparatus 12, using the number of carrier waves being used by the terminal apparatus 12. The communication control part 216 controls transmission speed of the communication part 211, in accordance with communication volume of the terminal apparatus 12 that has been calculated. For example, in a case where the communication volume of the terminal apparatus 12 is larger than the current transmission speed, the communication control part 216 increases the transmission speed of the communication part 211. And in a case where the communication volume of the terminal apparatus 12 is smaller than the current transmission speed, the communication control part 216 decreases the transmission speed of the communication part 211 (step 27).

### Description of Effect

With regard to the communication apparatus 21 of the second exemplary embodiment described above, the response index calculation part 212 calculates response index of the communication part 211, and forwards to the wireless environment identification part 213. The wireless environment identification part 213 performs a calculation (a prescribed operation) using the response index, and estimates the number of communication carriers being used by the terminal apparatus 12. The wireless environment identification part 213 forwards the number of communication carriers being used by the terminal apparatus 12 that has been estimated, to the communication control part 216. Since the communication control part 216 controls the communication speed of the communication part 211, based on the number of carrier waves being used by the terminal apparatus 12, it is possible to avoid a state in which communication performance of the terminal apparatus 12 cannot be sufficiently used. It is possible to prevent delay increase due to excessive transmission speed and execution of congestion control.

### Third Exemplary Embodiment

Next, a description is given concerning a third exemplary embodiment.

### Description of Configuration

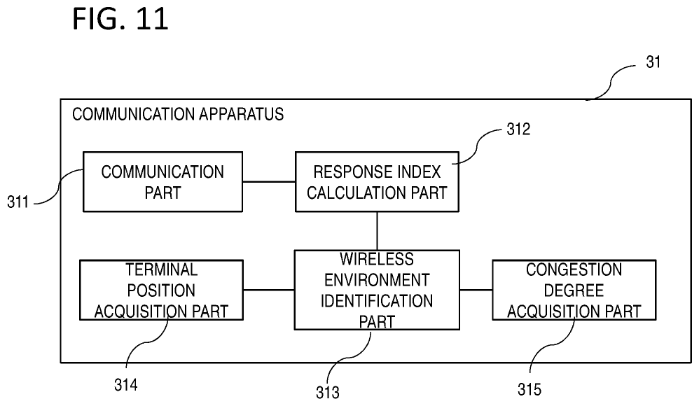

FIG. 11 is a block diagram showing a configuration example of a communication apparatus 31 according to a third exemplary embodiment of the present invention. The communication apparatus 31 is provided with a communication part 311, a response index calculation part 312, a wireless environment identification part 313, a terminal position acquisition part 314, and a congestion degree acquisition part 315. The response index calculation part 312 is connected to enable communication between the communication part 311 and the wireless environment identification part 313. The wireless environment identification part 313 is connected to enable communication between the response index calculation part 312, the terminal position acquisition part 314, and the congestion degree acquisition part 315.

The terminal position acquisition part 314 obtains position information of the terminal apparatus 12. For example, it is possible to use a method of obtaining position information of the terminal apparatus 12 by using a GPS (Global Positioning System) signal of the terminal apparatus 12 (position information calculated by the terminal apparatus 12 according to a GPS signal) and position information of a base station in communication with the terminal apparatus 12. The terminal position acquisition part 314 forwards position information of the terminal apparatus 12 obtained to the wireless environment identification part 313.

The congestion degree acquisition part 315 obtains the current degree of congestion in a communication area. Specifically, the congestion degree acquisition part 315 obtains the degree of congestion of the geographical position at the current time in real time. For example, the congestion degree acquisition part 315 connects to a public website providing an estimated number of people representing the degree of congestion for each area, and obtains the estimated number of people in a particular area on a map from the public website. The congestion degree acquisition part 315, after obtaining the degree of congestion, forwards the obtained degree of congestion to the wireless environment identification part 313.

The wireless environment identification part 313, after obtaining terminal position information from the terminal position acquisition part 314 and obtaining the degree of congestion from the congestion degree acquisition part 315, calculates the degree of congestion at the position of the terminal apparatus 12.

The wireless environment identification part 313 identifies the usage state of carrier aggregation of the terminal apparatus 12. Specifically, the wireless environment identification part 313 performs a calculation using the response index calculated by current communication. For example, in order to detect a sudden increase in delay, the wireless environment identification part 313 may perform addition of the arrival time of a TCP packet and relative change amount of timestamp. The wireless environment identification part 313 records the number of times the result of multiplication or addition of change amount and time of detection of timestamp exceeds a fixed response index calculation threshold. The wireless environment identification part 313 determines the number of carrier waves being used by the terminal apparatus 12, by the number of times in question being a prescribed number of times within a fixed period. A plurality of the abovementioned response index calculation threshold values are set (arranged) in advance, and based on the degree of congestion of the position of the terminal apparatus 12, one of the plurality of response index calculated values is selected to be used.

### Description of Operations

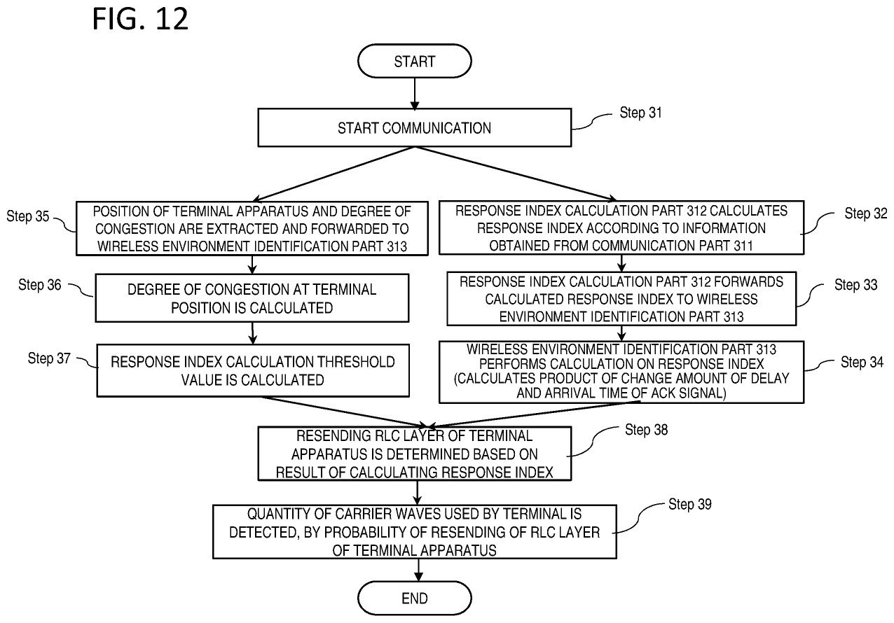

FIG. 12 is a flowchart showing an example of operations of the communication apparatus 31 of the third exemplary embodiment.

As described in the first exemplary embodiment, in a case of using carrier aggregation (CA), the probability of the occurrence of an event in which a delay occurring in a transport layer of the communication part 311 within a fixed time period suddenly increases, increases in comparison to a case where CA is not used. That is, the occurrence of the abovementioned event has a correlation with the number of carrier waves used at the same time by the terminal apparatus 12. Therefore, by using the probability of the occurrence of an event in which the delay suddenly increases, it is possible to identify the number of carrier waves used at the same time by the terminal apparatus 12.

When communication is started (step 31), the response index calculation part 312 of the communication apparatus 31 connects with the transport layer of the communication part 311, a timestamp listed in the header of a transmitted TCP packet and a timestamp listed in the header of a returned ACK packet are extracted, and a response index is calculated. The response index calculation part 312 records arrival time of data of the transport layer (step 32).

The response index calculation part 312 forwards the abovementioned timestamp and the data arrival time to the wireless environment identification part 313 (step 33).

The wireless environment identification part 313 calculates the difference of time of detection of the calculated adjoining response index and the difference of the change amount of the adjacent response index. By calculating the product of the arrival time of the TCP packet and the relative change of the timestamp, the wireless environment identification part 313 detects an event in which the terminal apparatus 12 cannot return ACK. The wireless environment identification part 313 multiplies or adds the abovementioned time difference and the abovementioned change amount, and the result thereof is a response index calculation result (step 34).

When communication starts, the terminal position acquisition part 314 and the congestion degree acquisition part 315 calculate degree of congestion at the position of the terminal apparatus 12. For example, the congestion degree acquisition part 315 connects to the Internet and obtains an estimated number of people in a particular area on a map from a public website. The terminal position acquisition part 314 obtains a GPS signal of the terminal apparatus 12. The terminal position acquisition part 314 and the congestion degree acquisition part 315 then forward the obtained terminal position and the degree of congestion to the wireless environment identification part 313 (step 35).

The wireless environment identification part 313 uses information obtained from the terminal position acquisition part 314 and the congestion degree acquisition part 315, and calculates the degree of congestion at the current position of the terminal apparatus 12. For example, the wireless environment identification part 313 calculates the abovementioned degree of congestion by counting the number of terminals in the current area of the terminal apparatus 12. The wireless environment identification part 313 may calculate the number of terminal connections with a base station in use by the terminal apparatus 12 and may calculate the degree of congestion (step 36).

Based on the calculated degree of congestion, the wireless environment identification part 313 selects (calculates) a response index calculation threshold corresponding to the degree of congestion at the current position of the terminal apparatus 12, from among plural response index threshold values set in advance. The state of congestion of the terminal apparatus 12 affects the calculated response index. For example, for the terminal apparatus 12, when communicating in a congested area there is a trend for delay increase and throughput decrease. Therefore, the wireless environment identification part 313 should select a response index calculation threshold that revises upward the response index in order to detect a sudden increase in delay. That is, in order to assure detection related to a sudden increase in delay, the wireless environment identification part 313 calculates the addition of the arrival time of a TCP packet and relative change amount of timestamp, and selects (calculates) response index calculation threshold compared to the calculation result (step 37).

The wireless environment identification part 313 compares the calculation result of the response index calculated in step 34, with the response index calculation threshold selected in step 37, and records the number of events in which the response index calculation threshold is exceeded, and time of event occurrence. In accordance with this result, the wireless environment identification part 313 makes a determination regarding re-sending in the RLC layer of the terminal apparatus 12 (step 38).

The wireless environment identification part 313 compares the number of occurrences in a fixed time period of events recorded in step 38 and a carrier waves number threshold series set in advance. Based on a result of the comparison, the wireless environment identification part 313 detects the quantity of carrier waves in use by the terminal (step 39).

### Description of Effect

With regard to the communication apparatus 31 of the third exemplary embodiment described above, the response index calculation part 312 calculates response index of the terminal apparatus 12 from the communication part 311, and forwards to the wireless environment identification part 313. The wireless environment identification part 313 uses information from the terminal position acquisition part 314 and the congestion degree acquisition part 315, and calculates the level of congestion at the current position of the terminal apparatus 12. Using the threshold (response index calculation threshold) selected based on the degree of congestion of the terminal apparatus 12, since the number of carrier waves is identified, the accuracy when identifying the number of carrier waves in use by the terminal apparatus 12 is improved, in comparison with the first exemplary embodiment.

### Fourth Exemplary Embodiment

Next, a description is given concerning a fourth exemplary embodiment.

### Description of Configuration

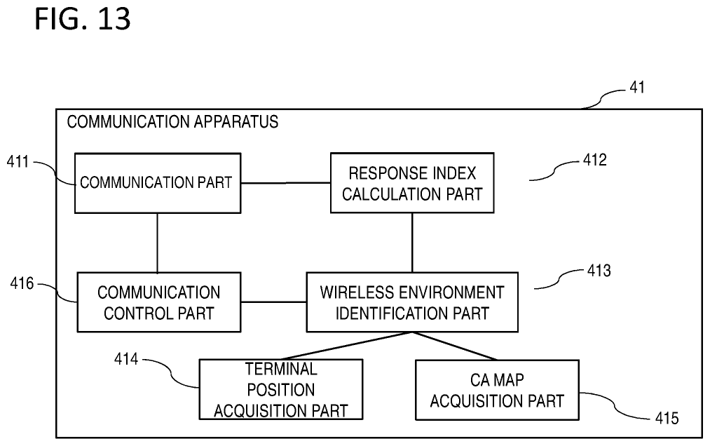

FIG. 13 is a block diagram showing a configuration example of a communication apparatus 41 according to the fourth exemplary embodiment of the present invention.

The communication apparatus 41 is provided with a communication part 411, a response index calculation part 412, a wireless environment identification part 413, a terminal position acquisition part 414, a CA map acquisition part 415, and a communication control part 416. The communication control part 416 and the communication part 411 are connected to enable communication with the wireless environment identification part 413.

The communication part 411 and the response index calculation part 412 are provided with functions similar to corresponding processing modules described in the first exemplary embodiment. The terminal position acquisition part 414 is provided with a function similar to a corresponding processing module described in the second exemplary embodiment.

The wireless environment identification part 413 records a response index received from the response index calculation part 412, and the time corresponding to the response index. The wireless environment identification part 413 calculates communication performance at respective times using these. For example, the wireless environment identification part 413 uses volume of data sent to the terminal apparatus 12 and measured RTT, and by calculating transmission throughput, calculates communication speed at each time.

The CA map acquisition part 415 obtains an installation map (CA map) of the current carrier aggregation. Specifically, the CA acquisition part 415 obtains the installation state of CA at a geographical position at the current time. For example, the CA acquisition part 415 connects to the Internet, and obtains the CA application state in a particular area published by a mobile network service provider. The CA map acquisition part 415, after obtaining the CA map, forwards it to the wireless environment identification part 413.

The wireless environment identification part 413, after obtaining terminal position information from the terminal position acquisition part 414 and obtaining the CA map from the CA map acquisition part 415, identifies (comprehends) the CA installation state corresponding to the position of the terminal apparatus 12. That is, the CA map acquisition part 415 obtains a CA compatible specification for a particular base station. For example, when the current position of the terminal apparatus 12 is determined to be a CA compatible area for up to 3 carrier waves, the wireless environment identification part 413 determines that CA use is possible for the terminal apparatus 12, and a state in which the terminal apparatus 12 uses 4 carrier waves is excluded.

The wireless environment identification part 413 identifies the usage state of carrier aggregation of the terminal apparatus 12. Specifically, the wireless environment identification part 413 performs a prescribed calculation with respect to a response index calculated in current communication. For example, the response index calculation part 412 uses the amount of data sent to the terminal apparatus 12 and measured RTT (response index), to calculate transmission throughput. The wireless environment identification part 413 performs a prescribed calculation on the calculated response index (for example, transmission throughput), and calculates the number carrier waves being used by the terminal apparatus 12. For example, the wireless environment identification part 413 calculates the probability of occurrence within a past fixed time (D1) of an event in which the transmission throughput exceeds a response index calculation threshold, and the probability of occurrence within a short time (D2) in comparison with the most recent D1, and calculates the difference thereof. D1 is 1 day for example, and D2 is 1 second for example, but other values are also possible. The wireless environment identification part 413 compares this difference and a threshold of the number of carrier waves set in advance. Based on a result of the comparison, the wireless environment identification part 413 calculates the number of carrier waves in use by the terminal apparatus 12.

The wireless environment identification part 413 forwards the number of carrier waves being used by the terminal apparatus 12 to the communication control part 416. The communication control part 416 controls the communication part 411, using the number of carrier waves being used by the terminal apparatus 12 that are received. For example, in a case where the wireless environment identification part 413 determines that the terminal apparatus 12 is using 3 carrier waves at the same time, the communication control part 416 calculates the transmission speed of the 3 carrier waves (for example, performs addition of capacity upper limits of respective carrier waves), and adjusts TCP parameters such as transmission buffer, congestion window or the like of the communication part 411.

### Description of Operations

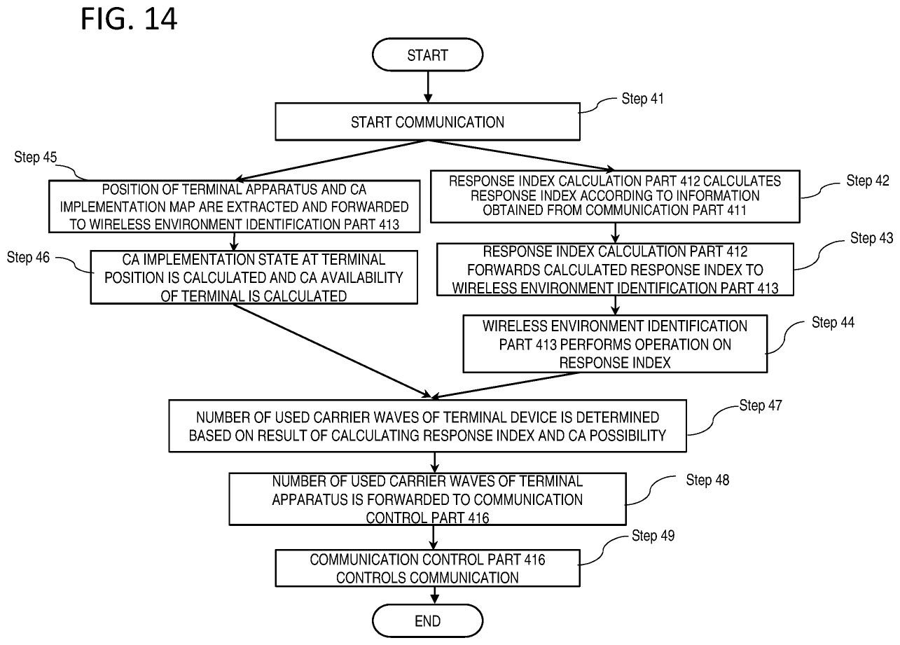

FIG. 14 is a flowchart showing an example of operations of the communication apparatus 41 of the fourth exemplary embodiment.

Similar to the first to third exemplary embodiments, in a case of using CA, the probability of the occurrence of an event in which a delay occurring in a transport layer of a communication part 411 within a fixed time period suddenly increases, increases in comparison to a case where CA is not used. That is, there is a correlation between the probability of occurrence of the event in question and the number of carrier waves used at the same time by the terminal apparatus 12. Since the transmission throughput is calculated by the transmitted data volume, an event occurs where transmission throughput suddenly deteriorates in the same way. The communication apparatus 41 according to the fourth exemplary embodiment uses the probability of occurrence of that event to identify the number of carrier waves used by the terminal apparatus 12 at the same time.

When communication starts (step 41), the response index calculation part 412 of the communication apparatus 41 connects with the communication part 411, and uses transmission data volume and RTT of the transport layer to calculate transmission throughput (step 42).

The response index calculation part 412 forwards the calculated throughput and the time of calculation of the throughput to the wireless environment identification part 413 (step 43).

The wireless environment identification part 413 performs calculation with regard to the response index. The wireless environment identification part 413 refers to the relationship between time stored in advance and communication performance, estimates the communication performance of the terminal apparatus 12 at the current time, and based on the estimated result, adds to the response index calculation threshold” set in advance. The wireless environment identification part 413 refers to the communication speed at the current time, and adds the response index calculation threshold based on the current estimated communication speed. The wireless environment identification part 413 calculates numerical distribution of the throughput historical values, and the numerical distribution within the most recent fixed time period of the throughput. The wireless environment identification part 413 calculates the history of probability of temporal occurrence of an event in which throughput deterioration exceeds response index calculation threshold, and the probability of temporal occurrence within the most recent fixed timer period (step 44).

The wireless environment identification part 413 obtains a current CA map from the CA map acquisition part 415. Specifically, the CA map acquisition part 415 obtains the CA application state in a particular area published by a mobile network service provider, and forwards to the wireless environment identification part 413. The terminal position acquisition part 414 obtains the terminal position and forwards it to the wireless environment identification part 413 (step 45).

The wireless environment identification part 413 refers to the position and CA corresponding area of the terminal apparatus 12, and reduces the CA usability of the terminal apparatus 12. For example, for the wireless environment identification part 413, in a case where the position of the terminal apparatus 12 is outside the CA area, the CA usability of the terminal apparatus 12 is limited to Non-CA (step 46).

The wireless environment identification part 413 compares the probability of occurrences in the most recent fixed time period for an event in which the deterioration of throughput has exceeded the response index calculation threshold, and the carrier wave numbers threshold series set in advance, and determines the number of carrier waves being used by the terminal apparatus 12. The wireless environment identification part 413 refers to the CA usability of the terminal apparatus 12 calculated in step 46. For example, the wireless environment identification part 413 sets the relationship between a series of probability threshold values and the number of carrier waves being used by a terminal in advance, compares the probability calculated in step 44 and the series of probability threshold values described above, and determines the number of carrier waves being used by the terminal. The wireless environment identification part 413 refers to the result of this determination and CA usability, and excludes carrier wave number calculation results that have error (step 47).

The wireless environment identification part 413 forwards (notifies) the number of carrier waves when the determined terminal is used, to the communication control part 416 (step 48).

The communication control part 416 controls the communication part 411, based on the number of carrier waves being used by the terminal apparatus 12. For example, the communication control part 416 calculates maximum communication volume of the terminal apparatus 12, based on the number of carrier waves being used by the terminal apparatus 12, forwarded from the wireless environment identification part 413. The communication control part 416 performs control so that communication speed of the communication part 411 does not exceed the maximum communication volume of the terminal apparatus 12 (step 49). The communication control part 416 may transmit a command to change the number of carrier waves used by the terminal apparatus 12, to the communication part 411. For example, the wireless environment identification part 413 determines that the terminal apparatus 12 is using a plurality of carrier waves. In this case, where the transmission speed of the communication part 411 is lower than the communication volume of the plurality of carrier waves, the communication control part 416 transmits a command to stop usage of a particular part of the carrier waves to the communication part 411, based on the volume of a combination of a part of the plurality of carrier waves.

### Description of Effect

In the communication apparatus 41 of the fourth exemplary embodiment described above, in addition to the response index, the wireless environment identification part 413 estimates the number of communication carriers being used by the terminal apparatus 12, based on the position of the terminal apparatus 12 and the implementation state of the CA at the position in question. With the communication apparatus 41 of the fourth exemplary embodiment, the CA implementation state at the position of the terminal apparatus 12 is referred to, and since it is possible to limit the number of candidates of communication carrier being used by the terminal apparatus 12 to within a fixed range, it is possible to estimate the number of communication carriers being used among the allocable number of carrier waves. As a result, with the communication control part 416, since it is possible to control the communication part 411, based on the number of carrier waves being used by the terminal apparatus 12 by the wireless environment identification part 413, it is possible to avoid a state in which communication performance of the terminal apparatus 12 cannot be sufficiently availed of. In addition, since the communication part 411 transmits a command to reduce the number of carrier waves used, matching the transmission speed of the terminal apparatus 12, it is possible to avoid unnecessary frequency allocation.

### Fifth Exemplary Embodiment

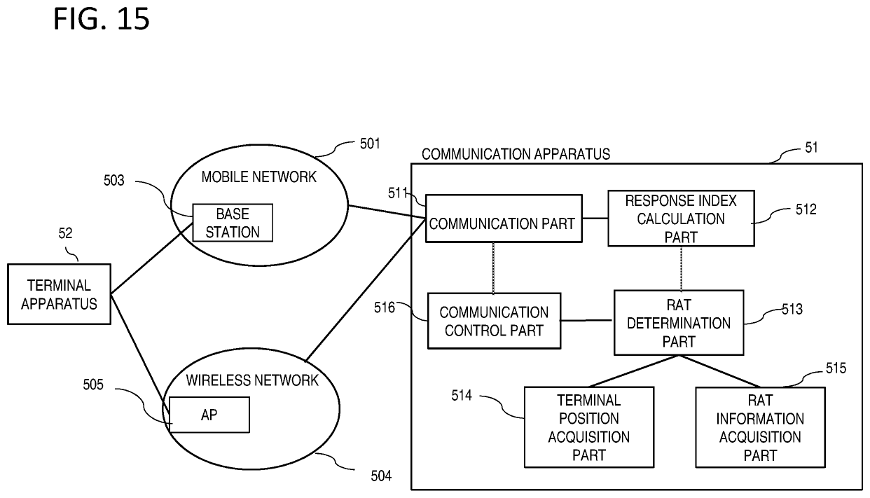

FIG. 15 is a block diagram showing a configuration example of a communication apparatus 51 according to a fifth exemplary embodiment.

The present exemplary embodiment is a method of determining plural RATs (Radio Access Technology) used by a terminal apparatus 52.

A mobile network 501 is provided with a base station 503. A wireless network 504 is provided with an AP (Access Point) facility that can connect with the terminal apparatus 52. The terminal apparatus 52 is connected to enable communication with the base station 503 of the mobile network 501. At the same time, the terminal apparatus 52 uses another wireless system (for example, Wi-Fi) to be connected to enable communication with the AP 505 of the wireless network 504. A communication part 511 of the communication apparatus 51 is connected to enable communication with the mobile network 501 and the wireless network 504.

The terminal apparatus 52 performs communication with the communication apparatus 51 via the base station 503 of the mobile network 501. At the same time, the terminal apparatus 52 performs communication with the communication apparatus 51 via the AP 505 (for example, a public Wi-Fi or a home wireless network) of the wireless network 504.

A response index calculation part 512 records the amount of data sent to the terminal apparatus 52. The response index calculation part 512 uses the transmission time and the time at which the terminal apparatus 52 returns an ACK signal, to calculate round-trip delay. The response index calculation part 512 uses the amount of data sent to the terminal apparatus 12 and the round-trip delay, to calculate the communication speed of the terminal apparatus 52. The response index calculation part 512 calculates packet loss of the communication part 511.

A RAT determination part 513 calculates the numerical distribution of the communication speed obtained from the response index calculation part 512. For example, the RAT determination part 513 calculates Cumulative Distribution Function (CDF) of the communication speed. The RAT determination part 513 compares the numerical distribution of the response index and the instantaneous value of the response index. For example, the RAT determination part 513 calculates the probability of occurrence of the instantaneous value of the response index based on the numerical distribution of the response index, compares with a threshold set in advance, and estimates the RAT usage state of the terminal apparatus 52. The RAT determination part 513 may calculate the numerical distribution within a most recent fixed time period of the response index, and compare with the distribution calculated from the history of the response index.

A RAT information acquisition part 515 obtains information of the RAT. For example, the RAT information acquisition part 515 obtains information regarding whether or not it is possible to use a wireless network 504 or a mobile network 501 at a particular place, by accessing a server or the like on the Internet. A judgement as to whether or not it is possible to use the wireless network 504 or the mobile network 501 at a particular place may be done by referring to a history showing unique relationships between RAT information and position of terminal stored in a communication apparatus. The RAT information acquisition part 515 obtains degree of congestion information regarding whether or not it is possible to use the wireless network 504 or the mobile network 501 at a particular place.

The RAT determination part 513 obtains position information of the terminal apparatus 52 from a terminal position acquisition part 514. The terminal position acquisition part 514 operates similarly to the fourth exemplary embodiment. The RAT determination part 513 calculates movement speed of the terminal apparatus 52 and uses information obtained from the RAT information acquisition part 515 to estimate RAT implementation state of the movement destination of the terminal apparatus 52. For example, the RAT determination part 513 judges whether or not there is a Wi-Fi AP at the movement destination of the terminal apparatus 52. The RAT determination part 513 calculates a threshold for the abovementioned comparison, based on the RAT implementation state of the movement destination of the terminal apparatus 52. The RAT determination part 513 forwards the result of calculating the RAT usage state of the terminal apparatus 52, to a communication control part 516. In a case where the terminal apparatus 52 uses LTE, the RAT determination part 513 determines the number of carrier waves used by LTE at the same time, and forwards to the communication control part 516, similar to the first to fourth exemplary embodiments.

The communication control part 516 controls the communication part 511. The communication control part 516 performs control so that only some among plural data communication paths are chosen. For example, when the communication part 511 transmits data at the same time to both the mobile network 501 and the wireless network 504, the communication control part 516 may cut connection with a low performance communication network (for example, when there is high packet loss in the wireless network 504, communication performance is affected). As a result, the communication performance is raised (improved).

### Description of Operations

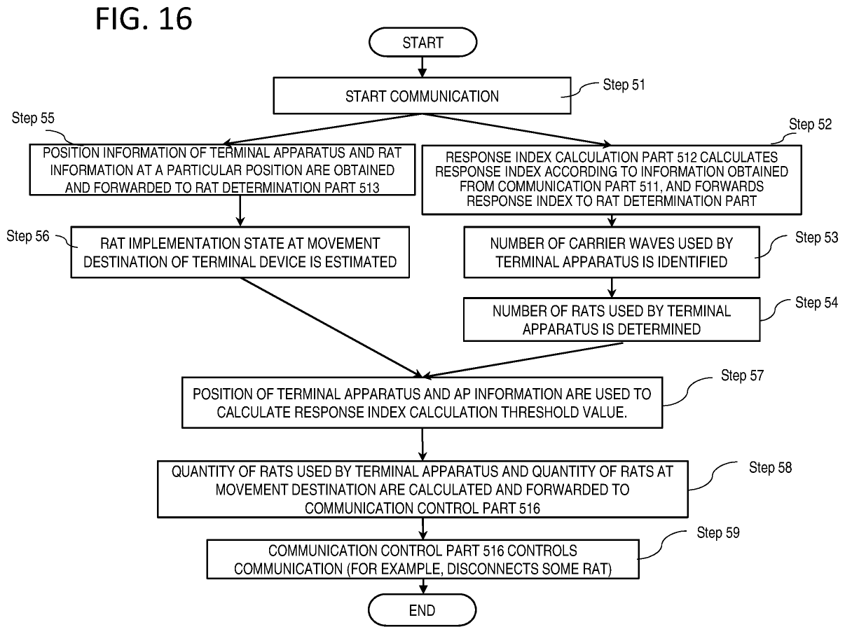

FIG. 16 is a flowchart showing an example of operations of the communication apparatus 51 of the fifth exemplary embodiment.

Similar to the first to fourth exemplary embodiments, in a case of using CA, the probability of the occurrence of an event in which a delay occurring in a transport layer of the communication part 511 within a fixed time period suddenly increases, increases in comparison to a case where CA is not used. That is, there is a correlation between the probability of occurrence of the abovementioned event and the number of carrier waves used at the same time by the terminal apparatus 52.

When communication is started (step 51), the response index calculation part 512 connects with the communication part 511, and uses packet size transmitted by the transport layer, transmission time, and ACK signal time, to calculate communication speed. The response index calculation part 512 calculates packet loss rate (response index) of the transport layer of the communication part 511, and forwards the calculated packet loss rate to the RAT determination part 513 (step 52).

The communication speed of the communication part 511 can be calculated with the transmitted data amount and RTT. A sudden deterioration event occurs similarly in transmission speed. Therefore, the RAT determination part 513 uses occurrence probability of the event in question, to determine the number of carrier waves used by the terminal apparatus 52 at the same time, similarly to the first to fourth exemplary embodiment (step 53).

Since the distribution probability of communication characteristic amount in the wireless network 504 is different from the distribution probability of communication characteristic amount in the mobile network 501, the terminal apparatus 52 discerns that the mobile network 501 and the wireless network 504 are being used at the same time. For example, when Wi-Fi is used, since packet loss rate in the transport layer is high, the RAT determination part 513 can discern that the terminal apparatus 52 is using Wi-Fi when the packet loss rate exceeds a fixed threshold (step 54). Or, when 3G is used, since average RTT of the transport layer is large, the RAT determination part 513 can discern that the terminal apparatus 52 is using 3G when the average RTT exceeds a fixed threshold.

The terminal position acquisition part 514 obtains position information of the terminal apparatus 52. The terminal position acquisition part 514 operates similarly to the fourth exemplary embodiment. The RAT information acquisition part 515 obtains RAT information for a particular position. For example, the RAT information acquisition part 515 obtains information concerning whether or not there is a public wireless access point at a particular position. The terminal position acquisition part 514 and the RAT information acquisition part 515 forward the obtained information to the RAT determination part 513 (step 55).

The RAT determination part 513 uses a time series of position information of the terminal apparatus 52 to calculate movement speed. In addition to considering information obtained from the RAT information acquisition part 515, the RAT determination part 513 estimates the RAT implementation state of movement destination of the terminal apparatus 52. For example, the RAT determination part 513 determines whether or not there is a public wireless network AP or an LTE base station at the movement destination of the terminal apparatus 52 (step 56).

The RAT determination part 513 uses the position of the terminal apparatus 52 and AP information to calculate response index calculation threshold. For example, if the RAT determination part 513 determines that a public wireless network cannot be used for the current position of the terminal apparatus 52, the calculation threshold for the response index (for example, packet loss rate) may be set in the same way as in the fourth exemplary embodiment. If the RAT determination part 513 determines that a public wireless network cannot be used for the current position of the terminal apparatus 52, the calculation threshold for the response index (for example, packet loss rate) may be set to be large. Or, a determination may be made that the terminal apparatus 52 used LTE and public Wi-Fi at the same time, for the reason that the packet loss rate increases to a certain level (step 57).

The RAT determination part 513 calculates the numerical distribution of the response index. For example, the RAT determination part 513 calculates Cumulative Distribution Function (CDF) of the packet loss rate and the communication speed. The RAT determination part 513 calculates distribution within any of the time range for the response index. For example, the RAT determination part 513 calculates distribution within the most recent 1 second for the response index. The RAT determination part 513 compares the numerical distribution of the response index and the instantaneous value of the response index. For example, the RAT determination part 513 calculates the probability of occurrence of the instantaneous value of the response index, compares with a threshold set in advance, and determines the CA usage state of the terminal apparatus 52. The RAT determination part 513 may calculate the numerical distribution within the most recent (immediately previous) fixed time period for the response index, and compare with the numerical distribution in the history of the response index. On this occasion, the RAT determination part 513, for example, uses a distribution function of history values of the response index, and calculates the numerical distribution probability within the most recent fixed time period for the response index. According to whether or not the probability reaches exceeds a prescribed threshold, the RAT determination part 513 determines the type of RAT being used by the terminal apparatus 52, and numbers of respective transport carriers. For example, with LTE, the number of transport carriers corresponds to the number of Component Carriers; and with Wi-Fi, corresponds to the number being simultaneously used, such as 2.4 GHz and 5 GHz (with Wi-Fi, it is possible to distinguish between 2.4 GHz and 5 GHz carriers). The RAT determination part 513 forwards the type and number of RATs used by the current terminal apparatus 52, and the type and number of available RATs at a movement destination of the terminal apparatus 52 (step 58).

The communication control part 516 uses the number of RATs being used by the terminal apparatus 52 received from the RAT determination part 513, and the RAT usage information of the movement destination of the terminal apparatus 52, to control the communication part 511 (step 59). For example, the terminal apparatus 52 at the current time uses the mobile network 501 and the wireless network 504 at the same time. When the terminal apparatus 52 moves to an area where the wireless network 504 cannot be used, the communication control part 516 curtails transmission speed of the communication part 511 in advance, and prevents performance deterioration by congestion control of TCP that occurs at the movement destination of the terminal apparatus 52. The communication control part 516 may select and control part of the wireless network and the mobile network. For example, when the communication part 511 transmits data at the same time to both the mobile network 501 and the wireless network 504, the communication control part 516 may cut connection with a low performance communication network (for example, when there is high packet loss in the wireless network 504, communication performance is affected). As a result, the communication performance is raised (step 59).

### Description of Effect

In the communication apparatus 51 of the fifth exemplary embodiment described above, by distinguishing characteristics of particular communications of respective RATs, the RAT determination part 513 determines the type of RAT being used by the terminal apparatus 52, and the number of carrier waves of each RAT. The communication control part 516 uses the determined number of RATs used by the terminal apparatus 52, and the type and number of available RATs at a movement destination of the terminal apparatus 52, to control the communication part 511, so as to enable prevention of performance deterioration by TCP congestion control. By the communication control part 516 selecting only a part of RATs in use, since negative effects of RATs with low communication preformation are excluded, communication preformation improves.

Some or all of the abovementioned exemplary embodiments may also be described as in the following mode or modes, but there is no limitation to the following.

### First Mode

A communication apparatus is provided with a terminal; a communication means for enabling transmission of a packet to the terminal via a frequency carrier of a base station to which the terminal is connected; a response index calculation means for calculating a response index of the packet; and a determination means for determining a number of the frequency carriers of the terminal that are used, in accordance with a response index calculation result of the response index calculation means.

### Second Mode

The communication apparatus according to the first mode, wherein determining the number of the frequency carriers being used includes determining by a number of carrier waves being used by the terminal.

### Third Mode

The communication apparatus according to the first or second mode, wherein the response index is calculated using at least one among: RTT (Round Trip Time), one-way delay, a time stamp described in a header of a communication packet, transmission throughput, communication speed, packet loss rate, and reception interval of response signals from the terminal.

### Fourth Mode

The communication apparatus according to any one of the first to third modes, wherein calculation by the response index calculation means includes calculating difference between instantaneous time value and average value of the response index.

### Fifth Mode

The communication apparatus according to any one of the first to fourth modes, wherein a method of determining the number of the frequency carriers of the terminal in use by the determination means includes comparing response index calculation result of the response index calculation means and one or a plurality of thresholds set in advance.

### Sixth Mode

The communication apparatus according to any one of the first to fifth modes, wherein communication flow to or from the terminal is controlled based on the number of the frequency carriers being used.

### Seventh Mode

The communication apparatus according to the first mode, wherein determining the number of the frequency carriers being used includes determining by the type of RAT (Radio Access Technology) of the terminal.

### Eighth Mode

A communication method for a terminal and a communication apparatus for enabling transmission of a packet to the terminal via a frequency carrier of a base station to which the terminal is connected, the method including: a response index calculation step of calculating a response index for the packet; and a determination step of determining a number of the frequency carriers of the terminal used, in accordance with a response index calculation result of the response index calculation step.

### Ninth Mode

A wireless communication system including a terminal; a base station to which the terminal is connected, and a communication apparatus that enables transmission of a packet to the terminal via a frequency carrier of the base station, wherein the communication apparatus includes a response index calculation means for calculating a response index of the packet; and a determination means for determining a number of the frequency carriers of the terminal that are used, in accordance with a response index calculation result of the response index calculation means.

### Tenth Mode

A program to make a computer execute control of a terminal and a communication apparatus that enables transmission of a packet to the terminal via a frequency carrier of a base station to which the terminal is connected, the program including: a response index calculation process of calculating a response index of the packet; and a determination process of determining a number of the frequency carriers of the terminal that are used, in accordance with a response index calculation result of the response index calculation process.

### Eleventh Mode

The communication apparatus according to any one of the first to third modes, wherein a method of determining the number of the frequency carriers of the terminal being used, by the response index calculation means, includes comparing history of probability of occurrence of an event in which the response index exceeds a prescribed threshold, and probability of occurrence of an event in which the response index exceeds a prescribed threshold within a most recent fixed time period.

### Twelfth Mode

The communication apparatus according to any one of the first to third modes, wherein a method of determining the number of the frequency carriers of the terminal being used, by the response index calculation means, includes adding the amount of change of detection interval of the response index, and the amount of change of the response index.

### Thirteenth Mode

The communication apparatus according to any one of the first to third modes, wherein a method of determining the number of the frequency carriers of the terminal being used, by the response index calculation means, includes multiplying the amount of change of detection interval of the response index, and the amount of change of the response index.

### Fourteenth Mode

The communication apparatus according to the fifth mode, wherein the determination means calculates the threshold based on an estimated level of congestion of the terminal.

### Fifteenth Mode

The communication apparatus according to the fifth mode, wherein the threshold refers to a relationship between time stored in advance and communication performance, estimates the communication performance of the terminal at the current time, and based on the estimated result, adds to the threshold set in advance.

### Sixteenth Mode

The communication apparatus according to the fifth mode, wherein for the threshold, movement speed of the terminal is calculated by a GPS (Global Positioning System) or a sensor of the terminal, movement destination of the terminal is estimated, and 1 value selected from a plurality of thresholds is included.

Seventeenth Mode

The communication apparatus according to any one of the first to fifth modes, wherein the determination means uses GPS (Global Positioning System) information of the terminal and service area of CA (Carrier Aggregation), and calculates the probability of actuating CA for the terminal.

### Eighteenth Mode

The communication apparatus according to any one of the first to seventh modes, wherein some of RAT (Radio Access Technology) or plural carrier waves being used by the terminal are cut, based on the number of the frequency carriers being used.

### Nineteenth Mode

The communication apparatus according to any one of the first to seventh modes, wherein some of plural carrier waves being used by the terminal are cut, based on the number of the frequency carriers being used.

### Twentieth Mode

The communication apparatus according to the first mode, wherein determining the number of the frequency carriers being used includes determining by the number of multiple layers transmitting to the terminal with the same carrier wave.

### Twenty-First Mode

The communication apparatus according to the first mode, characterized in that the communication apparatus is an apparatus outside of a communication terminal and a base station.

It is to be noted that the various disclosures of the cited Patent Literature described above are incorporated herein by reference thereto. Modifications and adjustments of exemplary embodiments and examples may be made within the bounds of the entire disclosure (including the scope of the claims) of the present invention, and also based on fundamental technological concepts thereof. Various combinations and selections of various disclosed elements (including respective elements of the respective claims, respective elements of the respective exemplary embodiments and examples, respective elements of the respective drawings, and the like) are possible within the scope of the entire disclosure of the present invention. That is, the present invention clearly includes every type of transformation and modification that a person skilled in the art can realize according to the entire disclosure including the scope of the claims and to technological concepts thereof. In particular, with regard to numerical ranges described in the present specification, arbitrary numerical values and small ranges included in the relevant ranges should be interpreted to be specifically described even where there is no particular description thereof.

### REFERENCE SIGNS LIST

11, 21, 31, 41, 51, 61 communication apparatus
12, 52 terminal apparatus
62 communication part
63 response index calculation part
64 determination part
81, 91 CPU
82, 92 memory
83, 93 input output interface
84 NIC
94 RF circuit
95 antenna
100 communication network
101, 101-1 to 101-n network
103, 503 base station
105 server
111, 211, 311, 411, 511 communication part
112, 212, 312, 412, 512 response index calculation part
113, 213, 313, 413 wireless environment identification part
121 terminal communication part
216, 416, 516 communication control part
314, 414, 514 terminal position acquisition part
315 congestion degree acquisition part
415 CA map acquisition part
501 mobile network
504 wireless network
505 AP
513 RAT determination part
515 RAT information acquisition part
1111, 1211 transport layer
1112 network layer
1113, 1213 MAC layer
1114, 1214 physical layer
1212 RLC layer

1. A communication apparatus, comprising
a communication part for enabling transmission of a packet to a terminal via frequency carrier(s) of a base station to which said terminal is connected;
a response index calculation part for calculating a response index of the packet; and
a determination part for determining a number of said frequency carrier(s) of said terminal being used, in accordance with a response index calculation result of said response index calculation part.

2. The communication apparatus according to claim 1, wherein determining the number of said frequency carrier(s) being used includes determining by a number of LTE (Long Term Evolution) carrier waves being used by said terminal.

3. The communication apparatus according to claim 1, wherein said response index is calculated using at least one among: RTT (Round Trip Time), one-way delay, a time stamp described in a header of a communication packet, transmission throughput, communication speed, packet loss rate, and reception interval of response signals from said terminal.

4. The communication apparatus according to claim 1, wherein calculation by said response index calculation part includes calculating difference between instantaneous time value and average value of said response index.

5. The communication apparatus according to claim 1, wherein a method of determining the number of said frequency carrier(s) of said terminal being used, by said determination part, includes comparing response index calculation result of said response index calculation part and one or a plurality of thresholds set in advance.

6. The communication apparatus according to claim 1, wherein communication flow to or from said terminal is controlled based on the number of said frequency carriers being used.

7. The communication apparatus according to claim 1, wherein determining the number of said frequency carriers being used includes determining by type of RAT (Radio Access Technology) of said terminal.

8. The communication apparatus according to claim 1, wherein a method of determining the number of said frequency carriers of said terminal being used, by said response index calculation part, includes comparing history of probability of occurrence of an event in which said response index exceeds a prescribed threshold, and probability of occurrence of an event in which said response index exceeds a prescribed threshold within a most recent fixed time period.

9. The communication apparatus according to claim 1, wherein a method of determining the number of said frequency carriers of said terminal being used, by said response index calculation part, includes adding amount of change of detection interval of said response index and amount of change of said response index.

10. The communication apparatus according to claim 1, wherein a method of determining the number of said frequency carriers of said terminal being used, by said response index calculation part, includes multiplying amount of change of detection interval of said response index and amount of change of said response index.

11. The communication apparatus according to claim 5, wherein said determination part calculates said threshold(s) based on estimated level of congestion of said terminal.

12. The communication apparatus according to claim 5, wherein said threshold(s) refer to a relationship between time stored in advance and communication performance, estimate communication performance of terminal at the current time, and based on the estimated result, add to the threshold(s) set in advance.

13. The communication apparatus according to claim 5, wherein for the threshold(s), movement speed of said terminal is calculated by a GPS (Global Positioning System) or a sensor of said terminal, movement destination of said terminal is estimated, and one value selected from a plurality of thresholds is included.

14. The communication apparatus according to claim 1, wherein said determination part uses GPS (Global Positioning System) information of said terminal and service area of CA (Carrier Aggregation), and calculates the probability of actuating CA for said terminal.

15. The communication apparatus according to claim 1, wherein some of a plurality of carrier waves or RAT (Radio Access Technology) being used by said terminal are cut, based on the number of said frequency carriers being used.

16. The communication apparatus according to claim 1, wherein some of a plurality of carrier waves being used by said terminal are cut, based on the number of said frequency carriers that are used.

17. The communication apparatus according to claim 1, wherein determining the number of said frequency carriers being used includes determining by the number of multiple layers transmitting to said terminal by the same carrier wave(s).

18. A communication method for a communication apparatus for enabling transmission of a packet to a terminal via frequency carrier(s) of a base station to which said terminal is connected, said method comprising:
calculating a response index of the packet; and
determining a number of said frequency carriers of said terminal being used, in accordance with a response index calculation result.

19. (canceled)

20. A non-transitory computer-readable recording storage medium storing a program to make a computer execute control of a communication apparatus that enables transmission of a packet to a terminal via frequency carrier(s) of a base station to which said terminal is connected, said program comprising:
a response index calculation process of calculating a response index of the packet; and
a determination process of determining a number of said frequency carrier(s) of said terminal being used, in accordance with a response index calculation result of said response index calculation process.
